(19) United States
(12) Patent Application Publication
(10) Pub. No.: US 2012/0180307 A1
(43) Pub. Date: Jul. 19, 2012

(54) LITHIUM-MANGANESE-TITANIUM CONDUCTIVE MATERIAL

(75) Inventor: CHENG-YU LAI, WEST GROVE, PA (US)

(73) Assignee: E. I. DU PONT DE NEMOURS AND COMPANY, Wilmington, DE (US)

(21) Appl. No.: 13/005,923

(22) Filed: Jan. 13, 2011

(51) Int. Cl. H01B 1/24; H01M 6/00; B05D 5/12; H01B 1/02; H01B 1/22

(52) U.S. Cl. 29/623.1; 252/519.12; 252/507; 427/122

(57) ABSTRACT

This invention relates to a process to make a lithium-manganese-titanium-containing compound, which can be used as an electrode material in a lithium ion battery. The process dissolves the constituent materials in a polar, organic solvent to form a compound described by the formula LiMn₍₂₋ₓ₎Ti₍ₓ₎O₄.

### TECHNICAL FIELD

This invention relates to lithium-manganese-titanium-containing conductive materials and processes for the preparation thereof.

### BACKGROUND

Kuzma et al (WO 2009/120,156) describe a process to synthesize LiMnTiO4 using metal salts, lithium methoxide and titanium isopropoxide.

Yang et al (CN 10/1,556,996) describe a method for preparing spinel type Li—Mn—Ti oxide cathodes, comprising mixing a lithium compound, a Mn salt and a Ti compound with ethanol, heating, drying, ball milling and performing thermal treatment. The manganese spinel or substituted spinel powders have usually been prepared by solid-state reaction which consists of mechanical mixing of lithium hydroxide, carbonate, or nitrate with manganese oxide, followed by high-temperature calcination and extended grinding. This method, however, often produces materials having the following characteristics: inhomogeneity, irregular morphology, larger particle size with broader particle size distribution, and poor control of stoichiometry.

A need nevertheless remains for improved processes for the preparation of lithium-manganese-titanium conductive materials.

### SUMMARY

In one embodiment, this invention provides processes for the preparation of an LiMnTi compound by (a) preparing a mixture of a lithium-containing material, a manganese-containing material, a titanium-containing material and a polar, organic solvent to form a solution thereof, (b) evaporating solvent from the solution to form a gel precursor, and (c) calcining the gel precursor in an oxygen-containing atmosphere to form a powder of an LiMnTi compound.

To facilitate rapid diffusion of lithium ions and thus to achieve excellent capacity, it is useful to apply a solution approach to obtain powders with good homogeneity, uniform morphology with narrow size distribution, and high surface area. The processes hereof also use a solution process to form a range of Li—Mn—Ti oxide stoichiometries. In addition, optional chelating agents can be used to achieve better mixing.

The LiMnTi materials obtained from the processes hereof may be used, for example, as an electrode in a lithium ion battery.

### DETAILED DESCRIPTION

The inventions hereof provide processes for the production of a conductive material that is described by the formula LiMn₍₂₋ₓ₎Ti₍ₓ₎O₄. In one embodiment hereof, an LiMnTi product as obtained herein can be described by the aforesaid formula in which the value of x is about 0.1 or more, or about 0.15 or more, or about 0.2 or more, or about 0.225 or more, and yet is about 0.4 or less, or about 0.35 or less, or about 0.3 or less, or about 0.275 or less. In another embodiment hereof, an LiMnTi product as obtained herein can be described by the aforesaid formula in which the value of x is about 0.001 or more, or about 0.005 or more, or about 0.01 or more, or about 0.02 or more, and yet is about 0.2 or less, or about 0.15 or less, or about 0.1 or less, or about 0.05 or less.

In the LiMnTi products as obtained by the processes of this invention, the value of x, and thus the relative content of the Mn and Ti, can be described by means of each and all of the ranges that can be formed from the selection of one of the maxima as set forth above together with one of the minima as set forth above. Thus, in a further embodiment, for example, x can be in the range of about 0.1 to about 0.3, or in the range of about 0.2 to about 0.4. Or, in yet another embodiment, x can be in the range of about 0.001 to about 0.1, or in the range of about 0.01 to about 0.2.

In one embodiment hereof, a process as provided by the inventions hereof begins with the dissolution of the constituent metal-containing materials, i.e. a lithium-containing material, a manganese-containing material and a titanium-containing material, in a solvent. Suitable for use to form such a solution are materials that are salts and/or compounds of the constituent elements. In one embodiment, for example, the solution can be formed from a lithium salt, a manganese salt and/or a titanium compound by admixing those materials with a solvent. A salt suitable for use herein is a material that is characterized by ionic binding between an anion and a cation. Salts usually dissolve in polar solvents such as water. A compound suitable for use herein is a material that may be ionically or covalently bonded, with the result that salts are compounds but not all compounds are salts.

The solution of a lithium-containing material, a manganese-containing material and a titanium-containing material can be formed in a polar, organic solvent to form a precursor to the desired product. When a lithium salt is used as the lithium-containing material, lithium salts suitable for use for such purpose include those selected from the group consisting of lithium nitrate, lithium chloride and lithium acetate, and derivatives thereof and mixtures thereof. When a the manganese salt is used as the manganese-containing material, manganese salts suitable for use for such purpose include those selected from the group consisting of manganese nitrate, manganese chloride, manganese sulfate and manganese acetate, and derivatives thereof and mixtures thereof. When a titanium compound is used as the titanium-containing material, titanium compounds suitable for use for such purpose include those selected from the group consisting of titanium isopropoxide, titanium ethoxide, tetrapropyl titanate, tetrabutyl titanate and titanium butoxide, and derivatives thereof and mixtures thereof. A polar, organic solvent suitable for use to form a solution of the lithium-containing material, manganese-containing material and titanium-containing material includes those selected from the group consisting of methanol, ethanol and other C₁˜C₁₀ linear, branched and cyclic alkyl alcohols, and derivatives thereof and mixtures thereof.

In an optional next step, a chelating agent is added to the mixture of metal-containing materials or the solution formed therefrom. A chelating agent suitable for addition to the above described solution includes those selected from the group consisting of citric acid, oxalic acid, and triethylamine or any type of soluble amino acid; and derivatives thereof and mixtures thereof. A chelating agent, when used, is used in an amount such that the moles of chelating agent is about 0.5 to about 1.5 times the total moles of metal added to the solution. A chelating agent, when used, is believed to coordinate with the ions, or the molecules of a compound, to facilitate their dispersion in the solvent.

Next in the processes hereof, the polar, organic solvent is evaporated to form a gel precursor, and the gel precursor is calcined at a temperature between about 600° C. and about 1000° C. in an oxygen-containing atmosphere at a pressure between 0.1 and 10 atmospheres (usually atmospheric pressure is used). The calcining may be conducted for a period of between about 6 to about 48 hours. Any organics present in the material, whether optional chelating agent or residual solvent, are burned off during calcining, and the product is typically obtained as a powder after calcining.

In the products obtained from the processes hereof, the ratios of lithium to manganese and lithium to titanium are selected to yield a product with a desired stoichiometry. For example, when making a product wherein, in the formula LiMn₍₂₋ₓ₎Ti₍ₓ₎O₄, x is in the range of between about 0.1 and about 0.4, it is preferred that an amount of materials be used to form the starting solution such that the molar ratio of lithium in the lithium-containing material to manganese in the manganese-containing material is in the range of between about 1 to about 1.6 and about 1 to about 1.9. It is further preferred that the molar ratio of lithium in the lithium-containing material to titanium in the titanium-containing material is in the range of between about 1 to about 0.1 and about 1 to about 0.4.

Correspondingly, in a further embodiment, when making a product wherein, in the formula LiMn₍₂₋ₓ₎Ti₍ₓ₎O₄, x is in the range of between about 0.15 and about 0.275, it is preferred that an amount of materials be used to form the starting solution such that the molar ratio of lithium in the lithium-containing material to manganese in the manganese-containing material is in the range of between about 1 to about 1.725 and about 1 to about 1.85. It is further preferred that the molar ratio of lithium in the lithium-containing material to titanium in the titanium-containing material is in the range of between about 1 to about 0.15 and about 1 to about 0.275.

Or, in a further embodiment, when making a product wherein, in the formula LiMn₍₂₋ₓ₎Ti₍ₓ₎O₄, x is in the range of between about 0.225 and about 0.35, it is preferred that an amount of materials be used to form the starting solution such that the molar ratio of lithium in the lithium-containing material to manganese in the manganese-containing material is in the range of between about 1 to about 1.65 and about 1 to about 1.775. It is further preferred that the molar ratio of lithium in the lithium-containing material to titanium in the titanium-containing material is in the range of between about 1 to about 0.225 and about 1 to about 0.35.

When making a product wherein, in the formula LiMn₍₂₋ₓ₎Ti₍ₓ₎O₄, x is in the range of between about 0.001 and about 0.2, it is preferred that an amount of materials be used to form the starting solution such that the molar ratio of lithium in the lithium-containing material to manganese in the manganese-containing material is in the range of between about 1 to about 1.8 and about 1 to about 1.999. It is further preferred that the molar ratio of lithium in the lithium-containing material to titanium in the titanium-containing material is in the range of between about 1 to about 0.001 and about 1 to about 0.2.

Correspondingly, in a further embodiment, when making a product wherein, in the formula LiMn₍₂₋ₓ₎Ti₍ₓ₎O₄, x is in the range of between about 0.005 and about 0.05, it is preferred that an amount of materials be used to form the starting solution such that the molar ratio of lithium in the lithium-containing material to manganese in the manganese-containing material is in the range of between about 1 to about 1.95 and about 1 to about 1.995. It is further preferred that the molar ratio of lithium in the lithium-containing material to titanium in the titanium-containing material is in the range of between about 1 to about 0.005 and about 1 to about 0.05.

Or, in a further embodiment, when making a product wherein, in the formula LiMn₍₂₋ₓ₎Ti₍ₓ₎O₄, x is in the range of between about 0.02 and about 0.15, it is preferred that an amount of materials be used to form the starting solution such that the molar ratio of lithium in the lithium-containing material to manganese in the manganese-containing material is in the range of between about 1 to about 1.85 and about 1 to about 1.98. It is further preferred that the molar ratio of lithium in the lithium-containing material to titanium in the titanium-containing material is in the range of between about 1 to about 0.02 and about 1 to about 0.15.

During calcining, a gel is formed when a further amount of solvent has evaporated from the gel precursor initially obtained from the original solution of salts, compounds and solvent; and a powder forms upon continued evaporation of solvent from the gel. A further embodiment of the inventions hereof thus involves steps to form a paste from a powder obtained from the processes as described above. To form a paste, a powder as obtained from a process hereof is admixed with binder, a vehicle (solvent) and carbon black. The role of the binder and the vehicle is to suspend and disperse the particulate constituents, i.e. the solids, in the paste with a proper rheology for typical patterning processes such as screen printing. Materials suitable for use as a binder include cellulosic resins such as ethyl cellulose and alkyd resins. Materials suitable for use as a vehicle include butyl carbitol, butyl carbitol acetate, dibutyl carbitol, dibutyl phthalate and terpineol.

A paste so formed may then be deposited on a conductive substrate to form an electrode. The conductive substrate may be an aluminum foil, a nickel foil, or a conductive carbon coated substrate. The substrate may be flexible or rigid, and the paste may be deposited by screen printing, brushing, dipping or spraying.

An electrode fabricated as described above may then be used to make a battery, typically as the cathode of the battery. Where the electrode has been fabricated from a paste as described above, but has been assembled with, for example, lithium foil, silicon, and carbon or metal oxides, it can be used as the anode of a battery. The anode and cathode in the battery are immersed in an electrolyte such as 1 molar of LiPF₆ in ethylene carbonate, dimethyl carbonate, diethyl carbonate, or ethyl methyl carbonate and mixtures thereof. The electrolyte transports lithium ions between the electrodes during battery charging and discharging. There may also be a porous separator structure, such as a fabric, installed between the electrodes to isolate them while allowing ion transport through the electrolyte.

In the process of making a battery, the electrolyte, which is a liquid or gel, is placed in a container. Frequently, the fabric separator is then placed in the electrolyte to maintain separation of the anode and cathode while allowing the flow of ions in the electrolyte between them. The electrodes are then inserted into contact with the electrolyte and optional separator between them.

### EXAMPLES

The advantageous attributes and effects of the processes hereof may be more fully appreciated from a series of examples, as described below. The embodiments of these processes on which the examples are based are representative only, and the selection of those embodiments to illustrate the invention does not indicate that materials, components, reactants, conditions, specifications, steps or techniques not described in these examples are not suitable for practicing these processes, or that subject matter not described in these examples is excluded from the scope of the appended claims and equivalents thereof.

All spinel metal oxide cathode materials used in the examples were prepared by the process described below. All formulations were sintered at a temperature in the range of 600° C. to 900° C. from 12 to 72 hours in air. All chemicals used in these examples were obtained from Aldrich-Sigma, and distilled water was purified by the Millipore system. A spinel of LiMn₂O₄, and a titanium-substituted spinel described by the formula LiMn₍₂₋ₓ₎Ti₍ₓ₎O₄, were both synthesized with and without the use of citric acid as a chelating reagent for the metal ions.

The products obtained as above were characterized by X-ray diffraction (XRD). The chemical compositions of the products were determined by an inductively coupled plasma-mass spectrometer. Scanning electron micrographs and transmission electron micrographs were collected for particle morphology with a Hitachi 54500 field emission microscope with an accelerating voltage of 5.0 kV. The samples were coated with a gold layer in order to prevent charge accumulation on their surface during the analysis.

Preparation without Citric Acid

Lithium acetate and manganese nitrate, both with and without tetrabutyl titanate as a titanium source, were dissolved in alcohol. After evaporating the solution, a yellow/brown gel was obtained. The gel was then calcined at 800° C. in air for 12 hours. This product was described by the above formula in which the value of x was in the range of 0.001 to 0.1.

Preparation with Citric Acid

A manganese salt and lithium salt, both with and without tetrapropyl titanate as a titanium source, was added in water to form a solution. To this solution, citric acid was added, with stirring, at a 1:1 molar ratio with the total metal ions. The prepared solution was mixed with a magnetic stirrer at 75° C. until a transparent gel occurred. The brown/black gel precursor was then dried. After cooling and grinding, calcination was conducted at 800° C. in air for 12 hours, followed by slow cooling to room temperature. This product was described by the above formula in which the value of x was in the range of 0.1 to 0.4.

In this product, a transparent gel was formed. The transparency of the gel indicated that its composition was very homogeneous. In the sol-gel process where citric acid was used as a chelating agent, the carboxylic acid group of citric acid is believed to have chelated with the mixed cations, resulting in a sol. During the sol formation process, the cations were distributed homogeneously throughout the chelating reagent structure, and did not cause cation segregation and subsequent precipitation. As most of the excess solvent was removed, the sol turned into a gel.

The x-ray diffraction patterns for this product indicate that it has a well-defined spinel phase with a space group Fd3m. SEM images of the powders prepared by the citric acid-assisted sol-gel process showed that they all had faceted structural morphology.

In general, the comparative LiMn₂O₄ products prepared as above without Ti substitution are characterized by less desirable performance, when they are used as battery electrodes, in terms of their ability to support repeated charging and discharging of the battery over numerous cycles.

In addition to vendors named elsewhere herein, various lithium, manganese and titanium materials suitable for use in the processes hereof may be made by methods known in the art, and/or are available commercially from suppliers such as Alfa Aesar (Ward Hill, Mass.), City Chemical (West Haven, Conn.), Fisher Scientific (Fairlawn, N.J.), Sigma-Aldrich (St. Louis, Mo.) or Stanford Materials (Aliso Viejo, Calif.).

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value.

In this specification, unless explicitly stated otherwise or indicated to the contrary by the context of usage, where an embodiment of the subject matter hereof is stated or described as comprising, including, containing, having, being composed of or being constituted by or of certain features or elements, one or more features or elements in addition to those explicitly stated or described may be present in the embodiment. An alternative embodiment of the subject matter hereof, however, may be stated or described as consisting essentially of certain features or elements, in which embodiment features or elements that would materially alter the principle of operation or the distinguishing characteristics of the embodiment are not present therein. A further alternative embodiment of the subject matter hereof may be stated or described as consisting of certain features or elements, in which embodiment, or in insubstantial variations thereof, only the features or elements specifically stated or described are present.

In this specification, unless explicitly stated otherwise or indicated to the contrary by the context of usage, amounts, sizes, ranges, formulations, parameters, and other quantities and characteristics recited herein, particularly when modified by the term “about”, may but need not be exact, and may also be approximate and/or larger or smaller (as desired) than stated, reflecting tolerances, conversion factors, rounding off, measurement error and the like, as well as the inclusion within a stated value of those values outside it that have, within the context of this invention, functional and/or operable equivalence to the stated value.

What is claimed is:

1. A process for the preparation of an LiMnTi compound, comprising:
(a) preparing a mixture of a lithium-containing material, a manganese-containing material, a titanium-containing material and a polar, organic solvent to form a solution thereof,
(b) evaporating solvent from the solution to form a gel precursor, and
(c) calcining the gel precursor in an oxygen-containing atmosphere to form a powder of an LiMnTi compound.

2. A process according to claim 1 wherein a lithium-containing material is added to the mixture in an amount such that the molar ratio of lithium in the lithium-containing material to manganese in the manganese-containing material is in the range of about 1 to 1.6 and about 1 to 1.9.

3. A process according to claim 1 wherein a lithium-containing material is added to the mixture in an amount such that the molar ratio of lithium in the lithium-containing material to titanium in the titanium-containing material is in the range of about 1 to 0.1 to about 1 to 0.4.

4. A process according to claim 1 wherein the LiMnTi compound is described by the formula LiMn₍₂₋ₓ₎Ti₍ₓ₎O₄ wherein x is in the range of about 0.1 to about 0.4.

5. A process according to claim 1 wherein a lithium-containing material is added to the mixture in an amount such that the molar ratio of lithium in the lithium-containing material to manganese in the manganese-containing material is in the range of about 1 to 1.8 and about 1 to 1.999.

6. A process according to claim 1 wherein a lithium-containing material is added to the mixture in an amount such that the molar ratio of lithium in the lithium-containing material to titanium in the titanium-containing material is in the range of about 1 to 0.001 to about 1 to 0.2.

7. A process according to claim 1 wherein the LiMnTi compound is described by the formula LiMn₍₂₋ₓ₎Ti₍ₓ₎O₄ wherein x is in the range of about 0.001 to about 0.2.

8. A process according to claim 1 wherein the lithium-containing material is selected from the group consisting of lithium nitrate, lithium chloride and lithium acetate, and derivatives thereof and mixtures thereof.

9. A process according to claim 1 wherein the manganese-containing material is selected from the group consisting of manganese nitrate, manganese chloride, manganese sulfate and manganese acetate, and derivatives thereof and mixtures thereof.

10. A process according to claim 1 wherein the titanium-containing material is selected from the group consisting of titanium isopropoxide, titanium ethodixe, titanium butoxide, tetrapropyl titanate, tetrabutyl titanate, and derivatives thereof and mixtures thereof.

11. A process according to claim 1 wherein the solvent is selected from the group consisting of C₁˜C₁₀ linear, branched and cyclic alkyl alcohols, and mixtures thereof.

12. A process according to claim 1 further comprising adding a chelating agent to the mixture or the solution.

13. A process according to claim 1 wherein the chelating agent is selected from the group consisting of citric acid, oxalic acid, triethylamine, and a soluble amino acid, and mixtures thereof.

14. A process according to claim 13 wherein the chelating agent is added to the mixture or solution in an amount such that the moles of chelating agent is about 0.5 to about 1.5 times the total moles of metal present therein.

15. A process according to claim 1 wherein calcining is conducted at a temperature between about 600° C. and about 1000° C.

16. A process according to claim 1 further comprising admixing an LiMnTi powder with a binder, a vehicle and carbon black to form a paste.

17. A process according to claim 16 further comprising depositing the paste on a conductive substrate to form an electrode.

18. A process according to claim 17 further comprising installing the electrode in a battery.
